(19) United States
(12) Patent Application Publication
(10) Pub. No.: US 2005/0255290 A1
(43) Pub. Date: Nov. 17, 2005

(54) Freezecast

(75) Inventor: Frank Drache, Aull (DE)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Drache Umwelttechnik GmbH

(21) Appl. No.: 11/061,584

(22) Filed: Feb. 18, 2005

(30) Foreign Application Priority Data
Feb. 20, 2004 (DE) 10 2004 008 691.5

(51) Int. Cl. B32B 3/10

(52) U.S. Cl. 428/131; 264/28; 264/69; 264/109

(57) ABSTRACT

A process for producing a shaped body for light-metal casting which is particularly simple and inexpensive to produce yet nevertheless satisfies the thermal and mechanical requirements is provided. The invention includes a process in which the starting materials provided are mixed then introduced into a mold. The mold is frozen and then the shaped body is removed from the mold and dried. Furthermore, the invention provides shaped bodies produced in this way and their use.

The present invention relates to a process for producing shaped bodies for light-metal casting and to shaped bodies produced in this manner and their use.

Shaped bodies for light-metal casting are known in various forms and materials. The materials have to have certain properties, such as for example a smooth surface, an ability to withstand thermal and mechanical loads and other properties. Since the shaped bodies are fitted at various locations within a casting installation, they are in a very wide range of forms.

For example, in the case of the horizontal casting of aluminum strands, the liquid aluminum flows out of a tundish through ceramic nozzles. Nozzles of this type are produced by machining blocks or plates, preferably of calcium silicate. The predefined final geometry is machined from the material by turning and/or milling. The shaped bodies produced in this way have a very rough surface at which voids and pores are often formed. Furthermore, there is a very high level of waste and chips formed during production of the shaped bodies in this way, which contributes to increased costs.

Therefore, it is an object of the invention to provide a process for producing shaped bodies for light-metal casting which is simple to employ and particularly inexpensive, leads to an improved surface of the shaped bodies and brings about the desired thermal and mechanical properties of the shaped body.

This object is achieved, in a very surprisingly simple way, by a process as claimed in claim 1, and by a shaped body as claimed in claim 14.

Accordingly, the process according to the invention for producing shaped bodies, such as for example casting nozzles, mold rings, intermediate pipes, sleeves and/or hot top rings, which are suitable for fitting in casting installations for light-metal casting, comprises the steps of providing the starting materials in a vessel and then mixing the starting materials. Then, a mold is filled with the mixed starting materials and is then frozen. After this, the shaped body formed is removed from the mold and the shaped body is thawed and dried.

The inventors have discovered that this process allows the production of near net shape shaped bodies, and therefore there is no need for the complex production process by milling and turning. It has also been found that the need to remachine the shaped bodies is eliminated completely or at least substantially which brings about a considerable time and cost saving. The shaped bodies produced in this way for light-metal casting have materials properties which are identical to or even better than shaped bodies for light metal casting which have been produced by conventional processes. It has been found that this process therefore makes a clear contribution to reducing costs combined with improved materials properties.

The inventors have discovered that inorganic oxides, in particular silicon oxide, inorganic powders, fine-grained amorphous silicon dioxide, organic peptizers and water are particularly suitable for use as starting materials. The inorganic oxides serve as network-forming agents, solvents, and binders, and the inorganic powder serves as a microstructure-forming agent, the fine-grained, amorphous silicon dioxide serves as fine grain or flux, the organic peptizer serves as temporary binder, peptizer and thickener, and the water serves as a pore-forming agent and solvent. It has been found that it is particularly simple to produce a slip from these materials. The slip produced from these materials is distinguished by a high structural viscosity and a pH of from 8 to 9, and is eminently suitable for further processing.

According to the invention, first of all the liquid starting materials are mixed with one another. The liquid starting materials are mixed by stirring. The slip which is formed is stirred for about five minutes. It has been found that this process step can be carried out by means of a commercially available mixer. Then, the amorphous silicon dioxide is added. It is mixed until homogenization has occurred. Then, the inorganic powder is added.

In one advantageous embodiment, the slip is introduced into a single-part or multi-part mold, in particular an oiled mold made from aluminum and/or a coated mold made from metal or plastic. This special shape makes it easy to remove the shaped body which has been formed and prevents the shaped body from being damaged when it is removed from the mold. The mold in this case already has the geometry which the shaped body is intended to acquire as its final geometry. This allows the production of various near net shape shapes.

Since the structure of the slip is very viscous and this may be disadvantageous in particular when filling molds of complicated geometries, it has been found that it is advantageous if the mold is filled on a vibratory table. This reduces the viscosity of the slip and makes it easier to fill the individual molds. This result can also be achieved by stirring or keeping in motion the slip for a longer time. However, the use of a vibratory table has the advantage of allowing the mold to be filled at the same time as maintaining a low viscosity of the slip. This can ensure optimum distribution of the slip throughout the mold.

Furthermore, the invention provides for the mold to be frozen by means of liquid nitrogen and/or dry ice and/or liquid air and/or heat exchangers. During freezing of the mold, the temperatures reach at most −70° C., preferably <−130° C., particularly preferably <−150° C.

On account of the low temperatures, the slip completely freezes within 2 to 10 minutes. The water crystallizes in the process. The SiO₂ remains from the silica sol, which means that the sol is converted into a gel. This is an irreversible process and the network which is formed is retained even in the event of thawing or drying. Since this procedure takes place within a few minutes, this represents a considerable time saving compared to other methods which have been used hitherto to produce shaped bodies.

It is particularly advantageous if the shaped body formed is removed from the mold with the aid of hot water or warm air. In this case, however, only the mold is heated slightly, and not the shaped body itself. This allows the shaped body to be removed from the mold without being damaged, which is particularly advantageous when producing shaped bodies for metal casting, since even minor damage to the surface of the shaped body may have a detrimental effect on its properties in terms of the flexural strength and the load-bearing capacity and may also have adverse effects on the casting process. The single-part or multi part mold which has already been mentioned above likewise makes a contribution to making it easy to remove the shaped body without damage.

It has been found that it is advantageous if the shaped body is thawed and partially dried over the course of several hours. This ensures that no stresses or cracks are formed in the shaped body.

According to the invention, the shaped body is dried until its weight is constant in a circulating-air drying cabinet. The temperature used should be around 110° C. The duration of the drying of the shaped body depends on its size and is normally from 4 to 6 hours. The shaped body formed already has a very high strength. It has been found that it is not necessarily disadvantageous for the shaped body not to undergo the partial drying forming part of the thawing process, but rather to be introduced directly into the drying cabinet. The temperatures which prevail there do not lead to the formation of cracks or stresses in the shaped body which have an adverse effect on its properties, but rather likewise allow uniform, careful drying of the shaped body.

A preferred embodiment of the invention provides for the shaped body then to be fired in a furnace, in particular a chamber furnace, at 500° C. to 1000° C., preferably 600° C. to 900° C., particularly preferably 650° C. to 700° C. In the process, the organic constituents and any residual water which is present are removed. The time for which the shaped body is held at the maximum temperature should be approximately 1 hour. This time is sufficient to remove the undesirable constituents from the shaped body.

The material of the shaped body, after it has been dried, can be machined by turning and/or drilling and/or grinding and/or milling should it prove necessary to do so. It has been found that the slip may swell slightly when it is frozen, which leads to an undulating surface of the shaped body. Should this occur, the surface is easy to machine and can thereby be improved.

In addition to the process according to the invention, the invention also comprises a finely porous ceramic shaped body to be fitted in casting installations for light-metal casting, in particular as a casting nozzle, mold ring, intermediate pipe, sleeve and/or hot top ring, which has pores with a diameter in the range from 2 μm to 8 μm, preferably 3 μm to 7 μm, particularly preferably 4 μm to 6 μm.

Particularly for shaped bodies which are used for light-metal casting, it has emerged that it is advantageous if the diameter of the pores is as small as this. Consequently, the shaped body can have a large number of pores and therefore has a low density. Nevertheless, it has good mechanical and thermal properties. The shaped body according to the invention is distinguished by the fact that it has a poor conduction of heat, which is especially important in particular in light-metal casting, since the casting process needs to take place without temperature loss from the metal melt.

Furthermore, shaped bodies configured in this manner are difficult for light-metal melts to wet and have a very smooth surface, which is likewise advantageous for the casting process, since it is in this way possible to ensure a good through-flow of the metal melt.

The shaped body according to the invention has a porosity of from 40% to 70%, preferably 50% to 65%, particularly preferably 55% to 62%. It is therefore extremely lightweight and has a good insulating action.

According to the invention, the shaped body includes a material which has a material shrinkage of less than 1%, preferably 0%, during production. This makes it possible to produce near net shape bodies which already have the desired final geometry, thereby eliminating the need for complex machining or remachining. Furthermore, the risk of the formation of cracks which have a detrimental effect on the materials properties of the shaped body is considerably reduced.

The inventors have discovered that it is advantageous if the shaped body consists of a material which contains SiO₂. This material causes the shaped body to have very good thermal properties, allowing it to be used at temperatures of up to at most approximately 900° C. Shaped bodies made from this material can also be stored in air.

The shaped body according to the invention is distinguished by the fact that it has a compressive strength of from 10 MPa to 16 MPa, preferably 11 MPa to 15 MPa, particularly preferably 12 MPa to 14 MPa. It is therefore able to withstand the forces which act on the shaped body for example during the casting of light metal. According to the invention, a shaped body of this type can be used for 300 casting cycles with in each case 10 t-12 t of metal melt per cycle, which likewise contributes to more efficient and less expensive production.

Furthermore, the shaped body according to the invention is distinguished by its thermal stability. This is required in particular when casting aluminum, since in this case the casting temperatures are in the range from 700° C. to 900° C.

Furthermore, the invention comprises a shaped body which can be produced by means of the process described above and is especially suitable for use for fitting in casting installations.

On account of the ease of producing various shapes by means of the process described above, it is possible for shaped bodies produced in this manner also to be used at a very wide range of locations in casting installations.

In the text which follows, the invention is explained in more detail on the basis of a preferred exemplary embodiment.

### EXEMPLARY EMBODIMENT

To produce a shaped body according to the invention, in this case a nozzle for the continuous casting process, 15% of water, 34.9% of a silica sol and 2% of a binder are mixed with one another by means of a commercially available food processor.

Then, 5% of a microsilica is added. All of this is then mixed together until homogenization has taken place. Experience has shown that this takes about 1 minute.

Then, 43.1% of wollastonite is added and the mixture is stirred for approximately 5 minutes. The result is a slip which has a high structural viscosity and a pH of between 8 and 9.

This slip is then introduced into a mold provided for the purpose. This is a two-part mold made from aluminum; molds made from other materials are also conceivable. It is advantageous if the mold has a coating or its inner side is oiled, so that the solid shaped body can subsequently be removed from the mold more easily.

The mold into which the slip is cast is already in the shape of a nozzle as is typically used in the continuous casting process.

The mold is filled with the slip on a vibratory table, which reduces the viscosity of the slip and therefore makes it easier to fill the mold.

This ensures uniform filling of the mold.

Then, the mold which has been filled with the slip is immersed in a bath containing liquid nitrogen at a temperature of approximately −196° C. The slip in the mold freezes from the outside inward over the course of 2 to 10 minutes; the time depends on the size of the mold.

It is conceivable that other processes which likewise allow cooling of this nature could also be used for this operation.

The water contained in the slip crystallizes out during this process, and the SiO₂ from the silica sol remains behind as a type of network. This network is distinguished by the fact that it is retained even after thawing and drying, and therefore the process is irreversible.

The shaped body is removed from the mold with the aid of hot water. This heats the oil on the inner surface of the mold so that the shaped body can be removed without damage. The advantage of the two-part mold used here should at this point be mentioned once again, since this likewise contributes to simple removal of the shaped body without damage, which could otherwise be disadvantageous in particular in the case of complicated shapes.

The shaped body which has been removed is thawed and partially dried for a few hours. Then, it is introduced into a circulating-air drying cabinet and dried until its weight is constant, which usually takes between 4 and 6 hours.

It is quite conceivable for the shaped body to be dried in other ways, but this method has proven especially quick and inexpensive.

Furthermore, it is possible for the frozen shaped body to be introduced directly into the drying cabinet without previously having been thawed and partially dried.

The dried shaped body is then fired in a chamber furnace which is gas-heated at approximately 700° C. for one hour. During this operation, the organic constituents and any residual water which may be present are removed from the shaped body.

Depending on what is required for the strength of the shaped body, the shaped body can also be used without having been fired in a gas furnace.

The slip may swell slightly during freezing, causing the shaped body to have an undulating surface. If this occurs, that side of the shaped body which comes into contact with the light-metal melt can be remachined.

The shaped body formed can be machined both in the dried state and in the fired state by turning, milling, drilling and grinding, which corrects and improves defects should it prove necessary to do so.

The embodiment illustrated here merely represents one example of the invention. However, the invention is not intended to be restricted to this example.

1-21. (canceled)

22. A process for producing shaped bodies for light metal casting installations, the process comprising the steps of:
providing a plurality of starting materials;
mixing the plurality of starting materials;
filling a mold with the plurality of starting materials;
freezing the plurality of starting materials to define a cast shaped body;
removing a cast shaped body from the mold; and
thawing and drying the cast shaped body.

23. The process as claimed in claim 22, wherein the step of providing comprises providing a plurality of inorganic oxides.

24. The process as claimed in claim 22, wherein the step of mixing comprises mixing a plurality of liquid starting materials together, adding a plurality of solid starting materials to the plurality of liquid starting materials, and mixing the plurality of liquid starting materials and the plurality of solid starting materials together.

25. The process as claimed in claim 22, wherein the step of mixing comprises stirring the plurality of starting materials.

26. The process as claimed in claim 22, wherein the mold is a two-part mold.

27. The process as claimed in claim 22, wherein the step of filling comprises filling the mold on a vibratory table.

28. The process as claimed in claim 22, wherein the step of freezing comprises freezing the plurality of starting materials with a medium selected from the group consisting of liquid nitrogen, dry ice, liquid air, heat exchangers, and any combinations thereof.

29. The process as claimed in claim 22, wherein the step of freezing comprises freezing the plurality of starting materials at a temperature of less than or equal to −70° C.

30. The process as claimed in claim 22, wherein the step of removing further comprises heating the mold.

31. The process as claimed in claim 22, wherein the step of thawing and drying comprises thawing and partially drying the cast shaped body over the course of at least about 1 hour.

32. The process as claimed in claim 22, wherein the step of thawing and drying comprises thawing and drying the cast shaped body in a circulating-air drying cabinet until the cast shaped body has a weight that is constant.

33. The process as claimed in claim 22, further comprising firing the cast shaped body in a furnace at 500° C. to 1000° C.

34. The process for producing shaped bodies as claimed in claim 22, further comprising machining the cast shaped body by a process selected from the group consisting of turning, drilling, grinding, milling, and any combination thereof.

35. A finely porous ceramic shaped body, comprising:
a plurality of pores with a diameter in a range from 2 micrometers to 8 micrometers.

36. The finely porous ceramic shaped body as claimed in claim 35, further comprising a porosity of 40% to 70%.

37. The finely porous ceramic shaped body as claimed in claim 35, further comprising a material with a material shrinkage of less than 1%.

38. The finely porous ceramic shaped body as claimed in claim 35, wherein the finely porous ceramic shaped body further comprises SiO₂.

39. The finely porous ceramic shaped body as claimed in claim 35, further comprising a compressive strength of 10 MPa to 16 MPa.

40. The finely porous ceramic shaped body as claimed in claim 35, further comprising a thermal stability of up to 900° C.

41. The process as claimed in claim 22, wherein the plurality of starting materials comprises inorganic oxides selected from the group consisting of the silicon oxide, inorganic powder, fine-grained amorphous silicon dioxide, organic peptizers, and water.

42. The process as claimed in claim 22, wherein the mold is oiled, and wherein the mold is aluminum.

43. The process as claimed in claim 22, wherein the mold is coated.

44. The process as claimed in claim 22, wherein the step of freezing comprises freezing the plurality of starting materials at a temperature of less than or equal to −130° C. to define a cast shaped body.

45. The process as claimed in claim 22, further comprising firing the cast shaped body in a furnace at 600° C. to 900° C.

46. The finely porous ceramic shaped body as claimed in claim 35, wherein the range is from 3 micrometers to 7 micrometers.

47. The finely porous ceramic shaped body as claimed in claim 35, further comprising a porosity of 50% to 65%.

48. The finely porous ceramic shaped body as claimed in claim 35, further comprising a compressive strength of 11 MPa to 15 MPa.

49. The finely porous ceramic shaped body as claimed in claim 35, further comprising a thermal stability of up to 880° C.

50. The process as claimed in claim 22, wherein the mold is plastic.
